(19) United States
(12) Patent Application Publication
(10) Pub. No.: US 2016/0006762 A1
(43) Pub. Date: Jan. 7, 2016

(54) METHOD FOR CREATING A PROFILE IN A SECURITY DOMAIN OF A SECURED ELEMENT

(71) Applicant: OBERTHUR TECHNOLOGIES, Colombes (FR)

(72) Inventors: Jerome DUMOULIN, Colombes (FR); Alexis MICHEL, Colombes (FR)

(21) Appl. No.: 14/768,449

(22) PCT Filed: Feb. 14, 2014
(86) PCT No.: PCT/FR2014/050306

§ 371 Date: Aug. 17, 2015

(30) Foreign Application Priority Data
Feb. 18, 2013 (FR) 1351354

(51) Int. Cl. H04L 29/06; H04W 12/02

(52) U.S. Cl. CPC H04L 63/166; H04W 12/02

(57) ABSTRACT

Disclosed is a method for creating a profile in a target security domain of a secure element. In various implementations, the method includes a reception operation by said target security domain, according to a secure protocol not interpretable by this security domain, of data comprising an installation script of said profile encrypted with a key of the target security domain; a transfer operation of data to a privileged security domain capable of interpreting the protocol; a decryption operation of said protocol by said privileged security domain to obtain said encrypted script; an operation for sending the encrypted script to said target security domain; and a decryption operation of said encrypted script with said key and execution of said script by the target security domain to install said profile. Other embodiments include systems and devices that implement similar functionality.

### BACKGROUND OF THE INVENTION

The present invention relates to the field of terminals comprising secure elements in which profiles can be installed.

The invention applies in particular and in a non-limiting manner to terminals whereof the secure elements are of type eUICC (“embedded UICC (Universal Integrated Circuit Card)”) and in particular to mobile phones, smartphones and the like.

For more information on UICC and eUICC secure elements, the person skilled in the art can refer respectively to the ETSI 102.221 standard and ETSI TS 103 383 specifications.

In this document, the notion of “profile” must be interpreted in the broad sense, specifically as a set of at least one file and/or data. A profile in terms of the invention can especially comprise at least one element of:
a standard file such as defined by the specifications of the 3GPP or of the ETSI for the UICC and their applications and especially by the 3GPP 31.102 and ETSI 102.221 standards;
a proprietary file;
a configuration file of an operating system;
a Java Card application and associated personalisation elements;
data such as transport protocol keys, parameters of authentication algorithm, . . .

Functionally, in most cases especially, a profile comprises data in relation to a service or a particular application, for example a bank application of NFC type (Near Field Communication), a telecommunication application or an application cooperating with a remote server via a mobile network.

For security reasons, to partition the different services offered by a terminal it is usual and recommended to register each of the associated profiles in its own security domain, such as defined by the document “Global Platform Card Specification 2.2.1”.

A solution for creating a new security domain in a secure element to install a new profile there is therefore preferred.

In the prior art, for creation and activation of a new security domain the GSMA recommends using a system comprising a security domain server and a security domain capable of communicating with this server according to a secure transport protocol, the securing of exchanges being performed by means of a key shared by these two entities.

Some contexts, and especially the eUICC project of the GSMA recommend using mechanisms of the Global Platform standard and in particular that according to the new security domain and that at the origin of its creation and its activation (father/son domains in terms of the standard) are isolated from each other as of activation of the son domain such that the father security domain cannot load a new profile into the security son domain.

In some contexts, and especially in the eUICC project of the GSMA, the new security domain must not be able to decrypt the secure transport protocol offered by this security domain server.

The aim of the invention is a solution for loading a new profile in a security domain of a secure element compatible with all these constraints.

### AIM AND SUMMARY OF THE INVENTION

Accordingly, and in general, the invention relates to a method for creating a profile in a target security domain of a secure element comprising a privileged security domain capable of communicating with a security domain server according to a secure transport protocol not decryptable by the target security domain.

This method comprises:
a reception step, by the target security domain, according to secure transport protocol, of data comprising an installation script of the profile, this script being encrypted with at least one key known from the target security domain;
a step during which the target security domain transfers the data to said privileged security domain according to the secure transport protocol;
a decryption step of the secure transport protocol by the privileged security domain to obtain the encrypted script;
a step during which said privileged security domain sends the encrypted script to the target security domain;
a decryption step of the encrypted script by the target security domain by using the above key(s); and
an execution step of this script by the target security domain to install the profile in said target security domain.

Correlatively, the aim of the invention is a secure element comprising:
a target security domain; and
a privileged security domain capable of communicating with a security domain server according to a secure transport protocol not decryptable by the target security domain; and in which
the target security domain comprises:
   reception means, according to the secure transport protocol, of data comprising an installation script of a profile encrypted with at least one key known from the target security domain;
   means for transferring these data to the privileged security domain according to the secure transport protocol;
the privileged security domain comprises:
   decryption means of the secure transport protocol to obtain the encrypted script;
   means for sending the encrypted script to the target security domain;
the target security domain comprising:
   decryption means of the encrypted script by using the above key(s); and
   execution means of the script to install the profile in the target security domain.

The above keys are keys which can especially be used for purposes of encryption/decryption and/or for purposes of authentication in mechanisms known per se for cryptographic securing of exchanges.

Consequently, according to the invention, the installation script of the profile is encrypted with at least one first key known from the target security domain, the encrypted profile itself being same encrypted according to the secure transport protocol decryptable by the privileged security domain.

In a particular embodiment, the method for creating a profile according to the invention comprises a step for creation and activation of the target security domain by the privileged security domain. This practice complies with the recommendations of the GSMA mentioned as a preamble to this document.

Preferably, this creation and activation step of the security domain comprises execution of a script by the target security domain to generate the above key(s).

In practice, this or these keys are shared between the target security domain and the entity, for example the operator or the service provider wanting to install the profile in this security domain.

Therefore, the target security domain and this operator/service provider can communicate as of activation of the target security domain by the privileged security domain.

In a particular embodiment of the method for creating a profile according to the invention, the target security domain transfers the data comprising encrypted the installation script to the privileged security domain by using a GlobalService interface of the Global Platform standard.

It is recalled that the GlobalService interface operates according to a mechanism of question/response type in which a first application requests service of a second application and then regains control after having obtained this service.

In a particular embodiment of the method for creating a profile according to the invention, the secure transport protocol used between the security domain server and the privileged security domain is the SCP80 or SCP81 protocol.

In a particular embodiment of the method for creating a profile according to the invention, the target security domain prepares a response which it encrypts with a key shared with the entity which requested creation of the profile (for example the operator) then requests the privileged security domain to cipher this encrypted response according to the secure transport protocol for transferring to the security domain server.

In a particular embodiment of the invention, the target and privileged security domains comply with the GlobalPlatform Card Specification 2.2.1 standard.

In a particular embodiment, the secure element according to the invention is constituted by an eUICC component such as defined by the ETSI 102 221 standard.

In a particular embodiment, the secure element according to the invention is constituted by an integrated circuit.

Another aim of the invention is a terminal incorporating a secure element such as mentioned hereinabove, for example a mobile phone.

This terminal comprises as known communication means specifically for communicating with the security domain server. These communication means utilise a known protocol, for example SMS protocol (Short Message service), CAT-TP protocol when the secure transport protocol is the SCP80 protocol, or the protocol HTTP when the secure transport protocol is the SCP81 protocol.

When the terminal receives the data comprising the encrypted installation script of the new profile, it preferably sends them to the secure element according to the invention by means of APDU commands (Application Protocol Data Unit) and/or according to the ISO7816 standard.

### BRIEF DESCRIPTION OF DRAWINGS

Other characteristics and advantages of the present invention will emerge from the following description, in reference to the appended drawings which illustrate an embodiment devoid of any limiting character. In the figures:

FIG. 1 illustrates, in the form of an organigram, the main steps of a method for creating a profile according to a particular embodiment of the invention; and

FIG. 2 illustrates a secure element according to a particular embodiment of the invention, incorporated into a mobile phone.

### DETAILED DESCRIPTION OF THE INVENTION

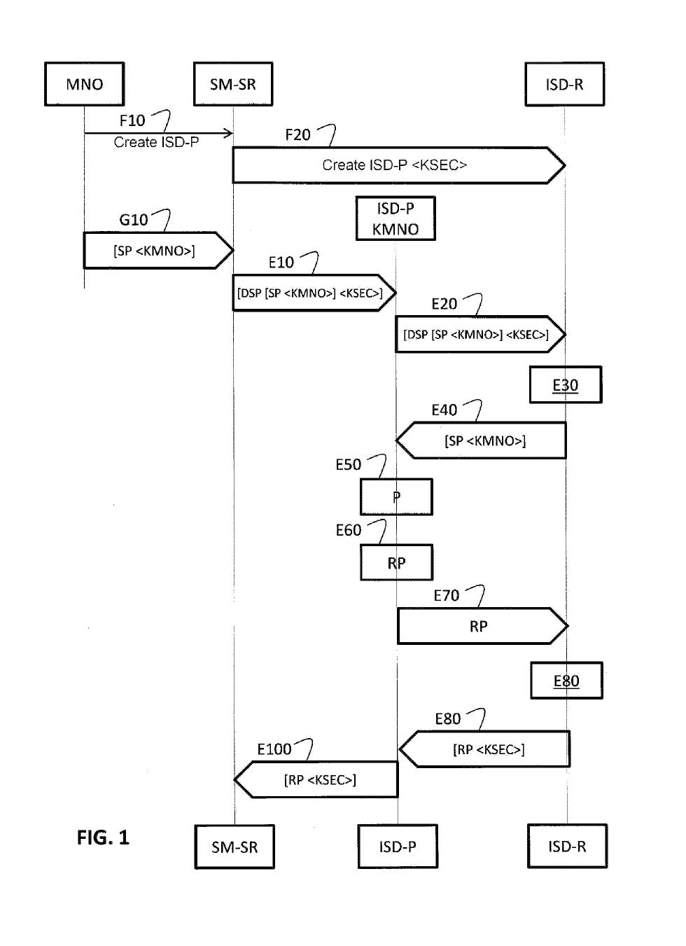

In reference to FIG. 1, an exemplary embodiment of the invention will now be described in which an operator MNO wants to install a new profile P in a secure element 10.

For this operation to be performed, it is necessary to previously create in the secure element 10 a target security domain reserved for this new profile P, this target security domain being referenced hereinbelow ISD-P (“Issuer Security Domain-Profile”).

The target security domain ISD-P is created, on request of the operator MNO (step F10) as is known, during a general step F20, and according to the recommendations of the GSMA, by using a server SM-SR (Subscription Manager Secure Routing) and a privileged security domain of the secure element 10 hereinbelow referenced ISD-R (“Issuer Security Domain-Root”).

The server SM-SR and the privileged security domain ISD-R share one or more secure keys KSEC and are each capable of using these keys to perform encryption/decryption functions, and/or authentication functions, and communicate via the mobile network according to a secure transport protocol, for example according to the SCP80 protocol (Secure Channel Protocol) or according to the SCP81 protocol.

The privileged security domain ISD-R is remarkable in that it has the capacity to create a new security domain on the secure element 10 and optionally the capacity to activate it, on receipt of commands (ENABLE, DISABLE . . . ) defined by the GSMA for the eUICC or commands (DELETE, INSTALL . . . ) complying with the Global Platform standard, these commands being received from the server SM-SR.

As is known, creating this new target security domain ISD-P comprises executing a script for creation of keys KMNO enabling secure communication between the operator MNO and the security domain ISD-P.

It is recalled that according to the Global Platform standard, the privileged security domain ISD-R can no longer access the services of the target security domain ISD-P, with the security domains ISD-R and ISD-P being isolated once the latter is activated. According to terminology of this standard known to the person skilled in the art, it is also said that the target security domain ISD-P is extradited.

How the invention allows the operator MNO to load the profile P into the target security domain ISD-P will now be explained.

During a step G10, the operator MNO sends a script SP for creating the profile P to the server SM-SR. This script is encrypted with at least one key KMNO of the operator MNO.

During a step E10, the server SM-SR sends data DSP comprising the script SP to the target security domain ISD-P by using the secure transport protocol, specifically the SCP80 or SCP81 protocol in this example. These data are encrypted with the key KSEC.

In practice, these data comprise information indicating that they are intended for the target security domain ISD-P. This information can especially be contained in a TAR field (Toolkit Application Reference) if the SCP80 protocol is used, or in an AID field (Application IDentifier) if the SCP81 protocol is used.

The target security domain ISD-P offers no service for communicating according to this secure transport protocol.

Consequently, and according to the invention, the target security domain ISD-P transmits the data DSP to the privileged security domain ISD-R during a step E20 so that the latter decapsulates the secure transport protocol. In practice, the security domain ISD-P invokes a service of the security domain ISD-R to complete this transfer.

In the embodiment described here, the security domain ISD-P target sends the data DSP to the privileged security domain ISD-R by using the GlobalService interface of the Global Platform Card Specification 2.2 standard.

The privileged security domain ISD-R decapsulates the secure transport protocol during a step E30, this decapsulation consisting especially of decrypting the data received and authenticating them by a signature verification mechanism.

The privileged security domain ISD-R sends the encrypted script SP with the key KMNO of the operator MNO to the target security domain ISD-P during a step E40.

During a step E50, the target security domain ISD-P decrypts and authenticates the script SP received from the security domain ISD-R by using the keys KMNO shared with the operator MNO, these keys KMNO having been created when the security domain ISD-P is produced (step F20). If the decryption and authentication operations proceed correctly the target security domain ISD-P installs the profile P in this security domain during this same step E50.

During a step E60, the target security domain ISD-P prepares a response RP intended for the server SM-SR to inform it of the success or failure of installation of the profile P.

The target security domain ISD-P is unable to communicate according to the secure transport protocol with the server SM-SR.

Consequently, in a particular embodiment, the target security domain IDS-P prepares a response RP which it encrypts with the key of the KMNO operator, then asks the privileged security domain ISD-R to cipher this encrypted response for secure transport to the server SM-SR (step E70).

In the embodiment described here, the security domain ISD-P target sends the encrypted response RP to the privileged security domain ISD-R by using the GlobalService interface of the Global Platform Card Specification 2.2 standard.

The privileged security domain ISD-R encrypts the response RP during a step E80 according to the secure transport protocol by using the key KSEC and sends the response encrypted according to this protocol to the target security domain during a step E90.

The target security domain ISD-P sends the encrypted response to the server SM-SR during a step E100.

Steps F10, F20, G10 and E10 to E100 are executed in this example in the order in which they are presented.

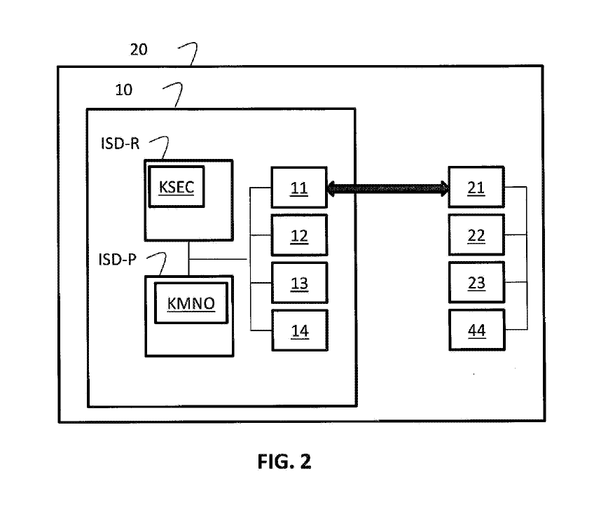

FIG. 2 shows a secure element 10 according to the invention in a particular embodiment of the invention.

This secure element 10 is incorporated into a mobile phone 20 comprising especially a processor 21, a RAM 22, a ROM 23 and communication means 24 over a mobile network. The secure element 10 is for example constituted by an integrated circuit.

In the embodiment described here, the communication means 24 are adapted to communicate with the security domain server SM-SR according to the CAT-TP protocol or according to the HTTP protocol security as a function of the used secure transport protocol SCP80 or SCP81.

In the embodiment described here, this secure element 10 is an eUICC component such as defined by the ETSI 102 221 standard. It comprises especially a processor 11, a RAM 12, a ROM 13 and communication means 24 with the processor 21 of the mobile phone.

The processor 11 is capable of executing the steps described previously in reference to FIG. 1.

In the embodiment described here, the mobile phone communicates with the security element 10 by means of APDU commands.

The secure element 10 comprises a target security domain ISD-P in which the profile P must be installed and a privileged security domain ISD-R capable of communicating with a security domain server SM-SR according to a secure transport protocol not decryptable by the target security domain ISD-P.

In practice, the privileged security domain ISD-R knows the encryption key(s) KSEC and offers communication, encryption/decryption or/and authentication services complying with this secure protocol, this key and these services not being known or offered by the target security domain ISD-P.

The target security domain ISD-P comprises one or keys KMNO shared with the operator MNO and encryption/decryption and/or authentication methods using this or these keys. These methods are adapted in particular to decrypt and/or authenticate the installation script of the profile P received from the privileged security domain ISD-R.

The target security domain ISD-P also comprises a process capable of executing this to install the profile P in said target security domain.

When the target security domain ISD-P receives data according to the secure transport protocol, it automatically invokes a process of the privileged security domain ISD-R to transfer these data to it. This is how it transfers the data DSP comprising the encrypted installation script of the profile P to the privileged security domain ISD-R.

The privileged security domain ISD-R comprises processes for decrypting the transport protocol with the key KSEC, this process being invoked to obtain the encrypted script.

The privileged security domain ISD-R is capable of invoking a method of the target security domain ISD-P to send it data. It uses this process especially to send the encrypted script to the target security domain.

1. A method for creating a profile in a target security domain of a secure element comprising a privileged security domain capable of communicating with a security domain server according to a secure transport protocol not decryptable by said target security domain, the this method comprising:
receiving, by said target security domain, according to said secure transport protocol, data comprising an installation script of said profile encrypted with at least one key known from said target security domain;
transferring, by said target security domain, said data to said privileged security domain according to said secure transport protocol;
decrypting said secure transport protocol by said privileged security domain to obtain said encrypted script;
sending, by said privileged security domain, said encrypted script to said target security domain;
decrypting said encrypted script by said target security domain by using said at least one key; and
executing said script by said target security domain to install said profile in said target security domain.

2. The method for creating a profile according to claim 1, wherein said target security domain transfers said data to said privileged security domain by using a GlobalService interface of the Global Platform standard.

3. The method for creating a profile according to claim 1, wherein said secure transport protocol is the SCP80 or SCP81 protocol.

4. The method for creating a profile according to claim 1, wherein said target security domain sends a response to said privileged security domain, this response being encrypted by said privileged security domain according to said secure transport protocol, the encrypted response being sent back according to the secure transport protocol to said target security domain for transferring to said security domain server.

5. The method for creating a profile according to claim 1, further comprising:
creating and activating said target security domain by said privileged security domain.

6. The method for creating a profile according to claim 5, wherein said creating and activating comprises execution of a script by said target security domain to generate said at least one key.

7. A secure element comprising:
a target security domain; and
a privileged security domain capable of communicating with a security domain server according to a secure transport protocol not decryptable by said target security domain; wherein:
said target security domain (ISD P) comprises:
reception means, according to said secure transport protocol, of data comprising an installation script of a profile encrypted with at least one key known from said target security domain;
means for transferring said data to said privileged security domain according to said secure transport protocol;
said privileged security domain comprises:
decryption means of said secure transport protocol to obtain said encrypted script;
means for sending said encrypted script to said target security domain;
said target security domain comprising:
decryption means of said encrypted script by using said at least one key; and
execution means of said script to install said profile in said target security domain.

8. The secure element according to claim 7, wherein said privileged security domain and said target security domain comply with the GlobalPlatform Card Specification 2.2.1 standard.

9. The secure element according to claim 7 comprising an eUICC component such as defined by the ETSI 102 221 standard.

10. The secure element according to claim 7, comprising an integrated circuit.

11. A terminal comprising a secure element according to claim 7.
